(19) United States
(12) Patent Application Publication
(10) Pub. No.: US 2026/0057806 A1
(43) Pub. Date: Feb. 26, 2026

(54) Artificial Human Respiration Simulator

(71) Applicants: Linda A. Frantz, Yukon, OK (US); Robert H. Frantz, Yukon, OK (US)

(72) Inventors: Linda A. Frantz, Yukon, OK (US); Robert H. Frantz, Yukon, OK (US)

(21) Appl. No.: 19/309,515

(22) Filed: Aug. 25, 2025

Related U.S. Application Data
(60) Provisional application No. 63/687,027, filed on Aug. 26, 2024.

(51) Int. Cl. G09B 23/32

(52) U.S. Cl. CPC G09B 23/32

(57) ABSTRACT

A system to simulate breathing by a human occupant of an enclosed structure, such as vehicle, for testing, validating and verifying operation of CO₂-based human presence detection systems, having a doll with dimensions corresponding to a specific human age, size, or both; a compressible breather bulb having an interior gas volume corresponding to a single breath gas volume corresponding to the specific human; an exhale gas reservoir which is collapsible at ambient atmospheric pressure; valves to control the movement of the exhale gas; wherein the reservoir collapses as gas is exhaled to simulate exchanging of gas during inhales and exhales.

### CROSS-REFERENCE TO RELATED APPLICATIONS

This non-provisional utility patent application claims benefit of the filing date of U.S. Provisional Patent Application No. 63/687,027, filed on Aug. 8, 2024, by Linda A. Frantz, et al.

### INCORPORATION BY REFERENCE

U.S. Provisional Patent Application No. 63/687,027, filed on Aug. 8, 2024, by Linda A. Frantz, et al., is incorporated by reference in its entirety, including drawings. U.S. Pat. Nos. 10,217,344 and 10,457,200, both issued to Michael T. Gage et al., are hereby incorporated by reference in their entireties, including drawings.

### FIELD OF THE INVENTION

The present invention relates to devices to simulate the breathing of an infant or child within an enclosed space.

### BACKGROUND OF THE INVENTION

Despite child publicity campaigns and various technology developments, children continue to be severely injured and even killed by heat stroke when trapped in hot cars. Many children are left in the car by their caregiver, and some actually enter the car on their own to retrieve a toy or snack and become locked in due to the child locks on the rear doors. Demographics collected of the caregivers indicate that it is not a careless adult who makes this horrific mistake, but most often is a “non-custodial caregiver” which includes neighbors, grandparents, aunts, uncles and adult friends who very often have been drafted to assist the custodial parent temporarily.

Many technologies have been proposed for detecting unaccompanied children in cars, vans, busses and trucks, each of which have coverage blind spots or types of occupancy which cannot be detected. For example, weight sensors in the bottoms of the vehicle's seats cannot detect a child who falls into the floorboard area and becomes unconscious. High-tech millimeter wave motion sensors may have their coverage severely blocked by solid objects, such as seat backs causing a “shadow” of coverage in a cargo area of an SUV. Door opening/closing counters may also be tricked if a child enters the driver's door with the driver and then moves to the middle or rear seat of the vehicle.

Some have proposed using other methods of detecting the presence of babies, infants, toddlers and children in cars. The detection of exhaled carbon dioxide (CO₂) is a promising technology because all humans, regardless of size, weight, age, and physical activity level, create and exhale CO₂ at levels many times greater than its level in ambient air. U.S. Pat. Nos. 10,217,344 and 10,457,200, issued to Michael T. Gage et al., currently embodied by technology available for Precious CarGo IP Ventures of Dallas, Texas, provide two such viable and operative detection technologies.

### SUMMARY

A system is disclosed which simulates breathing by a human occupant of an enclosed structure, such as vehicle, for testing, validating and verifying operation of CO₂-based human presence detection systems, having a doll with dimensions corresponding to a specific human age, size, or both; a compressible breather bulb having an interior gas volume corresponding to a single breath gas volume corresponding to the specific human; an exhale gas reservoir which is collapsible at ambient atmospheric pressure; valves to control the movement of the exhale gas; wherein the reservoir collapses as gas is exhaled to simulate exchanging of gas during inhales and exhales.

### BRIEF DESCRIPTION OF DRAWINGS

The figures presented herein, when considered in light of this description, form a complete disclosure of one or more example embodiments of the invention, wherein like reference numbers in the figures represent similar or same elements or steps.

FIG. 1 provides an example manner of use of an example embodiment according to the present invention.

FIG. 2 shows a side view of a typical sedan-type of vehicle.

FIG. 3 illustrates a first example embodiment for an infant respiration simulator according to the present invention.

FIG. 4 provides a second example embodiment for an infant respiration simulator according to the present invention.

FIG. 5 shows a third example embodiment for an infant respiration simulator according to the present invention.

FIG. 6 illustrates a photograph of an actual prototype according to the present invention as tested.

### DETAILED DESCRIPTION

Testing and validation of CO₂-based occupant detection systems is required to establish operational accuracy of experimental as well as production units. However, because of the hot conditions in which their operation is intended, it is not ethical nor advisable to use actual human subjects, such as live human infants, for such testing and validation.

For these reasons, the present inventors have invented a range of human simulators, which we will refer to in this document as Artificial Infant Respiration Simulator (AIRS), to include the smallest of occupants (newborn babies) up to and including pre-teens, such as a 12 year old child. Hot car death statistics show that children older than this are generally not at risk, probably because they are aware of how to free themselves from any type of booster seat restraints and seat belts, and how to exit through the front doors if the child-proof locks on the rear doors are engaged. Ordinarily skilled persons in the relevant arts will recognize that embodiments of the present invention are not limited to detection of infants and children in vehicles, and that the present breathing simulator can be realized in other embodiments to simulate adults as well as children who may become trapped in other enclosed structures such as, but not limited to, refrigerators, freezers, footlockers, storage cabinets, safe rooms, storm shelters, and vending machines. As such, while the present disclosure will use infants and children for the example embodiments, there is no corresponding limitation to the embodiments of the present invention.

While different babies and children, like adults, have varying degrees of respiratory activity such that individuals may exhale more or less CO₂ under normal activity, during sleep, and during periods of excitement, the range of CO₂ produced by infants to pre-teens is reasonably predictable. For example, a study of the CO₂ concentration of the surrounding air of sleeping infants conducted by Gert-Jan Braun et al. of the University of Eindhoven in 2020, and published by Taylor & Francis in the International Journal of Ventilation (2021, Vol. 20, Nox. 3-4, pgs. 161-171), shows that there is very little difference in the volume of air inhaled, and presumptively exhaled, by male or female children at any given age. For example, both male and female babies from birth age to up to 1 year old exhaled about 300-310 liters per kilogram body mass per day when sleeping or napping. At ages 6-11, this drops to about 55-60 l/kg-day, but still the same whether female or male. These researchers simulated exhalations of infants at 30-60 breaths per minute, with a CO₂ concentration of 4 to 5% (e.g. approximately 40,000 to 50,000 ppm), which is nearly 100 times more concentrated than ambient CO₂ of about 400 ppm. In order to simulate their exhaling operations, they used a pump, a CO₂ tank, a mass flow regulator, a timer and a three-way valve with a hose connected to the nose of a baby doll.

While this configuration, and these target exhale criteria, are interesting from a laboratory perspective, the present inventors found it had several shortcomings. Firstly, it was an expensive and elaborate configuration. Secondly, the present inventors believe that it does not in fact adequately simulate how an infant may contribute to the rise of CO₂ concentrations in an enclosed space, such as inside a car, truck or SUV. For example, CO₂ has a molecule shape which moves readily with heat currents or convention, and a baby's body temperature and solar gain of a car parked in the sunlight will convect the CO₂ throughout the car. This study mentions heat of the surfaces, but this study did not attempt to simulate how CO₂ might move away from a baby's body due to bodily heat and/or solar gain. Another example is the exit velocity of the test configuration from the baby doll's nose. Baby's will exhale with a relatively low velocity of breath if sleeping not crying, while it is not clear if the high-pressure tank of CO₂ with the valve opened momentarily was regulated to simulate this low velocity of exhale, or if the CO₂ was allowed to exit at nearly the tank's internal pressure. Finally, unlike an open-top crib or open-sides child's bed, the enclosed space within a vehicle has a finite volume, i.e. a limited number of liters of “air” in the vehicle. Simply squirting CO₂ into the enclosed space only adds CO₂ to the “air” mix, but does not actually simulate how a baby's or child's inhalation removes a quantity of gases from the mix in the enclosed, captive air. So, as the baby inhales and consumes oxygen O₂ molecules, these molecules are removed from the air mix in the vehicle, and CO₂ are exhaled in their place. This causes the percentage of CO₂ in the cabin air mix to rise faster, in reality, than simply adding CO₂ to the air mix while leaving (not removing) O₂ in the amounts corresponding to actual inhalation.

For these reasons, the present inventors disclose an occupant respiration simulator which adequately replicates both inhalation and exhalation activities of an infant up to a pre-teen human child. It is inexpensive to construct, operate, and more accurately simulates the exchange of gasses in an enclosed space (volume) of a vehicle, including but not limited to, volume of breaths, reduction of inhaled gasses, production of exhaled gasses, and natural convection due to body mass and heat. Various embodiments can simulate any size, weight, age and activity level of a human child.

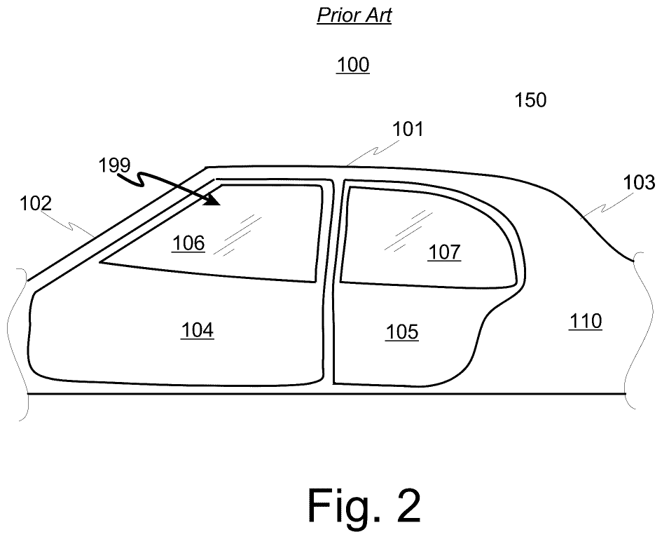

Referring now to FIG. 2, a side view of an example vehicle, such as a four-door sedan, is shown for illustrative purposes. Embodiments of the present invention may be utilized in other vehicles, such as but not limited to two-door vehicles, hatch-back vehicles, mini-vans, vans, SUVs, trucks and busses, in which the air volume is essentially contained when the windows and doors are shut and closed. This portion 100 of a vehicle has a top 101, body side 110, doors 104, 105, windshield 102, one or more rear or back windows 103, one or more side windows 106, 107, which form an essentially continuous physical boundary around an enclosed space 199 having a determinable volume (in liters, cubic meters, etc.) of fairly captive air. We will, for the purposes of this disclosure, refer to two states of that air: a state of air mix of gasses and temperature prior to abandonment of a child, and a changing or transition state of air mix and temperature after the abandonment of a child. The latter presumes that the inside environmental controls (e.g., fan, air conditioning, etc.) are off, and the doors and windows are shut and closed.

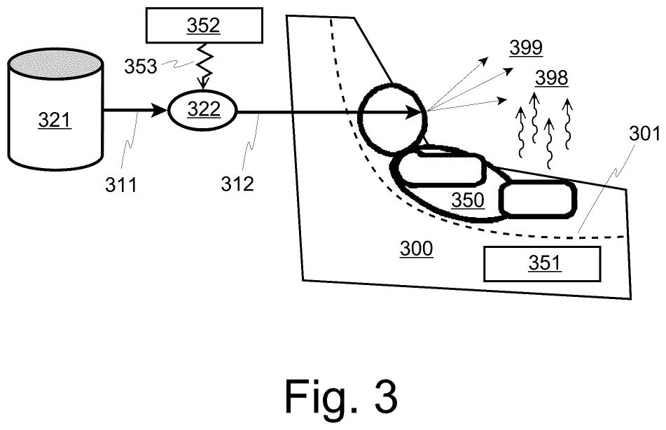

Referring now to FIG. 3, a first example embodiment to simulate a newborn baby is shown. It includes commercially available car seat 300 rated for newborn up to a 40 pound child, a doll 350 having a length suitable for displacing the same amount of air as a human infant (e.g., 19″ tall or long in our prototype), and an body-heat generator 351. The seat 300 has a seating surface 301 for receiving the doll. A reservoir of exhale gas mix 321 is in gas-communication through a collapsible breather bulb 322, which is in gas communication to a position near the face of the doll 350, using flexible hoses, pipes or tubes. The breather bulb 322 is sized to simulate an inhale and exhale gas volume of an infant, and is preferably velocity-limited to preclude the exhaled gasses from exceeding the velocity of an infant's actual breath. The breather bulb is compressed 353 manually or by machine at a rate suitable for the simulated child size and activity, such as 40 breaths per minute (bpm) for a relatively calm infant in this example embodiment.

Further, a combined weight (or mass) of the doll 350 and the body-heat generator 351 approximates the weight (or mass) of the corresponding baby or child in order to adequately simulate the convection of the CO₂ within the vehicle cabin naturally caused by a real baby or child.

For this particular embodiment, a 19″ realistic-proportion doll of 6 pounds in weight was used with a 4-pound phase-change material (PCM) infant warming blanket Incublanket [TM] available from Warmilu, LLC, of Arbor, Michigan, USA, as described in U.S. Pat. No. 9,605,874, as the body-heat simulator. A Tribute [TM] model convertible car seat for 5-40 lb children available from Evenflow of Piqua, Ohio, USA, was used for the car seat.

The breather bulb and velocity regulation valves were repurposed from an AMBU Bag SPUR II Infant Resuscitator Bag Valve Mask (BVM) available from AED Superstore of Woodruff, Wisconsin, USA. The infant mask was removed, and flexible tubing was connected from the output (exhale side) of the AMBU bag to a position near the face of the doll and pointing away from the face. The oxygen reservoir bag was removed, and a large Mylar balloon was attached by tubing to the input (inhale) side of the AMBU bag to serve as the reservoir of exhale gas mix.

This configuration allows the exhale-mix (e.g., 20% CO₂) gas to be stored in the Mylar balloon at ambient atmospheric pressure, rather than at above-ambient pressure like a pressurized tank or a stretching balloon would do, which eliminates the need for a pressure regulator in the configuration. Further, the Mylar balloon can be placed inside the vehicle prior to testing so that it displaces a volume of space that reduces as each breath is drawn from it and moved through the bulb to the face exit of the doll. In this way, the actual exchange of gasses liter-for-liter which occurs during real breathing is simulated, as well.

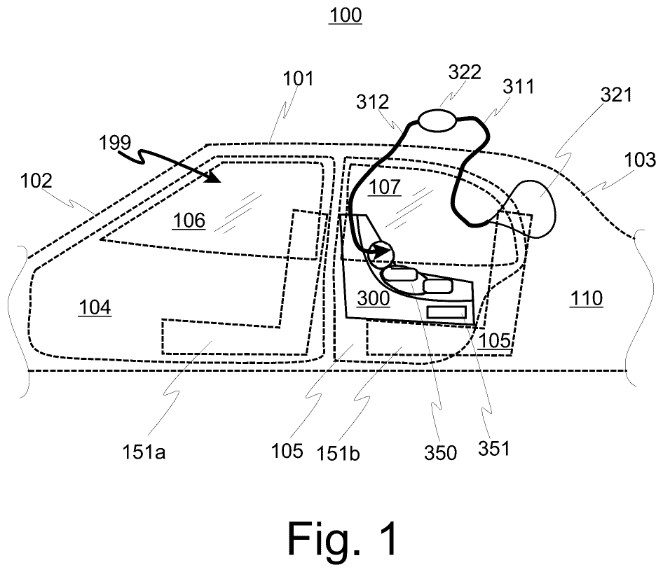

During testing usage, the seat, doll and heater are placed inside the vehicle, such as in a rear seat as shown 100 in FIG. 1. In this example manner of usage, the reservoir 321 of exhale gas mix is placed inside the vehicle as well, such as in the back window area of a sedan, and the input and output hoses 311, 312 are routed through a small opening left in the window 107 so that that breathing bulb 322 can be operated by hand. The opening of the window is sealed such as by foam insulation or tape, and a metronome can be used to roughly time the squeezes of the breathing bulb at the desired breathing rate, such as 40 breathes per minute.

The breathing bulb 322 can be compressed by hand, as in the testing and experiments described above, or it can be compressed mechanically 352 by a machine according to the desired breathing cadence in other embodiments such as in an automated test environment. A bulb-compressing machine such as that described by Pasupuleti et al. In U.S. Pat. No. 11,207,481 B2 assigned to Biodesign Innovation Labs Private Ltd. may be suitable to automate the bulb compressions. In other embodiments, a collapsible bellows maybe used in place of the breathing bulb and/or in place of the exhale gas reservoir.

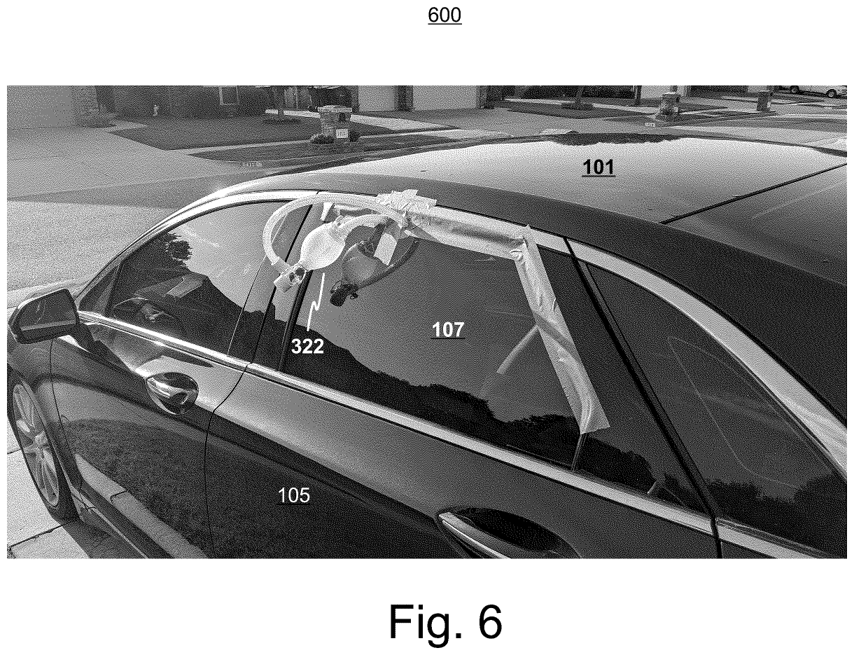

FIG. 6 shows 600 an actual configuration of this example embodiment with a mid-size sedan, specifically in this example a 2015 Lincoln MKZ Hybrid having a specification interior volume of 96.4 ft³ or about 2,730 liters. The breather bulb 322 is located outside the rear door window in this example configuration, with the input and outpul hoses passing between the top of the window glass and the window frame, with the remaining gap sealed by tape or foam insulation. Tape was found to be easy to use, however for reusability, foam tubes often used to insulate pipes or as pool floats (“pool noodles”) was also found to be reusable and repositionable. Air leakage between the inside of the vehicle and the exterior atmosphere was minimized for this example operation and test.

With each squeeze of the breathing bulb, a small volume of the exhale gas mix is moved from the reservoir 312, through the bulb, and into the interior of the vehicle near the face of the doll, with a velocity and volume similar to that of an actual infant. The heat from the body heater and from the solar gain of the vehicle will convect the exhaled gas mixture into the cabin realistically, providing a suitable challenge for a CO₂-based occupancy detector to detect.

During testing, the reservoir was observed to properly deflate, and the CO₂ level was observed using test equipment located on the dashboard in front of the front passenger seat (maximum diagonal distance from the artificial infant respiration simulator) to rise from 444 ppm (ambient expected value) to 668 ppm in about 200 breaths at 40 breaths per minute, which accounts for about 5 minutes elapsed time during the test. It is known that the test equipment is about 20 seconds behind in reporting the realtime value of the CO₂ it senses, so that makes the CO₂ rise across the cabin from the AIRS to occur at about 4.5 minutes. Additionally, it was not a hot or particularly sunny day at 72F outside, and 88F rising to 91F inside the vehicle, so the effects of solar gain were simulated somewhat mildly. Further, the body heat simulator was not included in this configuration, so that additional convection to move the CO₂ to the test equipment did not occur. Further testing may determine how much faster CO₂ may be detected when convection from solar gain and/or body heat is added.

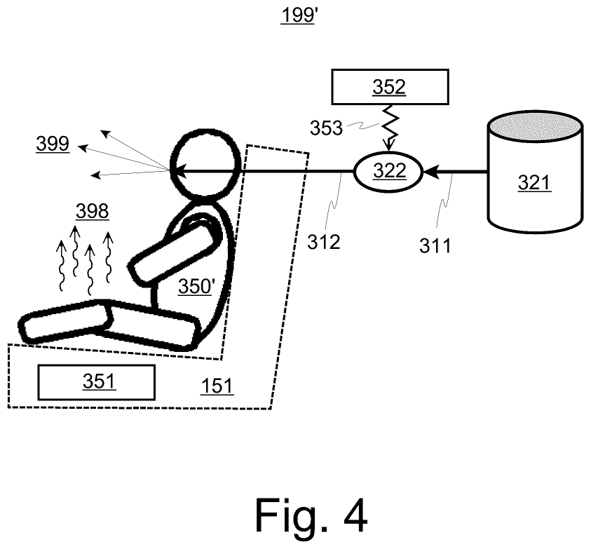

Referring now to FIG. 4, a larger doll 350′ simulating a 10 or 11 year old child is shown seated directly into the vehicle's seat 151 in another embodiment of the present invention such that exhaled breaths 399 are emitted into the surrounding area 199′ per the goals and objectives of the present invention.

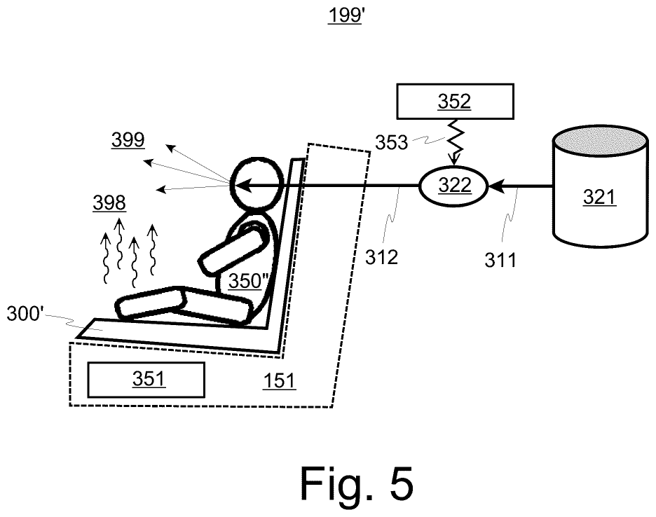

Referring now to FIG. 5, a larger doll 350″ simulating a 3-8 year old child is shown in a booster seat 300′ in another embodiment of the present invention such that exhaled breaths 399 are emitted into the surrounding area 199′ per the goals and objectives of the present invention.

Conclusion. The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof, unless specifically stated otherwise.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. An artificial human respiration simulator comprising: a doll having physical dimensions corresponding to a specific human age, size, or both age and size, including an approximate weight, height and bodily displacement volume;
a compressible breather bulb having an interior gas volume corresponding to a single breath gas volume corresponding to the specific human age, size, or both age and size;
an exhale gas reservoir which is collapsible at ambient atmospheric pressure;
a first one-way valve disposed in gas communication between the exhale gas reservoir the breather bulb, allowing exhale gas to be drawn from the reservoir into the breather bulb upon expansion of the breather bulb, and preventing gas transfer from the breather bulb to the gas reservoir; and
a second one-way valve disposed in gas communication between the breather bulb and an exhale port positioned near a face of the doll, the second one-way valve allowing exhale gas to be forced from the breather bulb and out the exhale port upon compression of the breather bulb, and preventing gas transfer from exhale port into the breather bulb;
thereby providing a decrease in a gas volume displacement of the exhale gas reservoir corresponding to the single breath gas volume with each compression-expansion operation of the breather bulb and simulating gas exchange of a human of the specific age, size, or both age and size.

2. The artificial human respiration simulator as set forth in claim 1 further comprising a body heat generator corresponding to a specific human age, size, or both age and size, and being located in a proximity of the doll.

3. The artificial human respiration simulator as set forth in claim 1 further comprising a gas velocity limiter in gas communication with the exhale port, having a gas velocity limit corresponding to the specific human age, size, or both age and size.

4. The artificial human respiration simulator as set forth in claim 1 wherein the exhale gas reservoir comprises a non-stretchable envelope.

5. The artificial human respiration simulator as set forth in claim 4 wherein the non-stretchable envelope comprises a polyester film envelope.

6. The artificial human respiration simulator as set forth in claim 5 wherein the polyester film envelope comprises a metallized polyester film envelope.

7. The artificial human respiration simulator as set forth in claim 5 wherein the non-stretchable envelope comprises a polyester film biaxially-oriented polyethylene terephthalate (BoPET).

8. The artificial human respiration simulator as set forth in claim 1 wherein the exhale gas reservoir comprises a bellows.

9. The artificial human respiration simulator as set forth in claim 1 wherein the body heat generator comprises a phase-change material (PCM) heat generator.

10. The artificial human respiration simulator as set forth in claim 1 further comprising an automated compressing mechanism associated with the breather bulb and providing a compression rate corresponding to the specific human age, size, or both age and size.

11. A method of using the artificial human respiration simulator as set forth in claim 1 comprising placing at least the doll and the exhale gas reservoir within an enclosed structure for simulation of human presence within the structure.

12. The method as set forth in claim 11 wherein the enclosed structure comprises a vehicle passenger compartment.

13. The method as set forth in claim 11 wherein the enclosed structure comprises a vehicle cargo compartment.

14. The method as set forth in claim 11 wherein the enclosed structure comprises a storage cabinet.

15. The method as set forth in claim 11 wherein the enclosed structure comprises a refrigerator.

16. The method as set forth in claim 11 wherein the enclosed structure comprises a freezer.

17. The method as set forth in claim 11 wherein the enclosed structure comprises a footlocker.

18. The method as set forth in claim 11 wherein the enclosed structure comprises one or more units selected from the group consisting of a vending machine, a clothes washer, a clothes dryer, a storm shelter, and a safe room.
